(19) United States
(12) Patent Application Publication
(10) Pub. No.: US 2008/0140310 A1
(43) Pub. Date: Jun. 12, 2008

(54) SYSTEMS AND METHODS FOR PREPARING DIRECTIONAL INSTRUCTIONS

(75) Inventor: Nils Graef, Santa Clara, CA (US)

Correspondence Address: HAMILTON AND DESANCTIS, 8555 W. BELLEVIEW AVE., LITTLETON, CO, 80123, US

(73) Assignee: Agere Systems Inc.

(21) Appl. No.: 11/608,902

(22) Filed: Dec. 11, 2006

(51) Int. Cl. G01C 21/20

(52) U.S. Cl. 701/206

(57) ABSTRACT

Various systems and methods for preparing directional instructions are disclosed herein. For example, a method for preparing directional instructions is discussed that includes receiving two route end points and identifying a route between the two end points. The route between the two end points may include, for example, at least one road and a distance. In addition, at least one landmark is identified along the route. A textual output is assembled that includes the name of the road, the distance and a description of the landmark.

### BACKGROUND OF THE INVENTION

The present invention is related to mapping systems, and more particularly, to systems and methods for providing textual direction instructions.

Systems for providing route information have been developed. For example, Google™ maps and Mapquest™ provide an ability to obtain graphical instructions for moving between two end points. Such graphical instructions include a two dimensional map that is displayed on a computer screen or printed. A route is drawn on the map for a suggested route between two end points. The route includes one or more roads and distances to be traveled. Further, the systems offer an ability to obtain driving directions in a textual format. For example, the systems provide instructions such as, “make a left on Main Street and go for 1.2 miles”. While such instructions are generally helpful, a user that either lacks an operable odometer or fails to carefully monitor an available odometer may become hopelessly lost by utilizing such instructions. Indeed, in some cases, such instructions may actually be worse than no instructions at all.

Hence, for at least the aforementioned reasons, there exists a need in the art for advanced systems and methods for geographic directing.

### BRIEF SUMMARY OF THE INVENTION

The present invention is related to mapping systems, and more particularly, to systems and methods for providing textual direction instructions.

Various embodiments of the present invention provide methods for preparing directional instructions. Such methods include receiving two route end points, and identifying a route stretching between the two route end points. The identified route includes at least one road and at least one distance. Further, a landmark along the route is identified. A textual output is prepared that includes the name of the road, the distance and a description of the landmark. In some cases, one of the route end points is located along the road and is identified in the textual output by which side of the road it is on. For example, where the address to be found is 163 Main Street, the textual instructions may direct you onto Main Street going a known direction and in addition indicate the side of the street that 163 is located. As a more particular example, the textual instructions may say “turn right onto Main Street, and building number 163 will be on the left side (or right side) of the road.” Based on the disclosure provided herein, one of ordinary skill in the art will recognize a number of other directional instructions including an indication of street side that may be possible in accordance with the various embodiments of the present invention. In some instances of the aforementioned embodiments, the methods further include identifying a distance from the landmark to one of the route end points, and including the distance from the landmark in the textual output.

In some cases, more than one landmark is identified. In such cases, one of the identified landmarks may come before a particular route end point and another of the identified landmarks may come after the particular route end point. As such, the latter landmark serves to inform a user of when they have traveled too far and need to turn around. In other cases, more than one road is identified. In such cases, the identified landmark may be near a transition between two or more of the identified roads.

Some instances of the aforementioned embodiments include accessing an Internet website tailored for identifying routes to obtain the initial route information. Further, identifying the landmarks may include accessing one or more Internet websites for entities located along the identified route. Such an approach to identifying landmarks may include deriving a description of a landmark associated with an entity. Where the landmark is located along the identified route, the landmark description may be used in the textual output. In some particular instances of the aforementioned embodiments, one of the end points includes a building number and the landmark includes a group of buildings in proximity to the building number. In other particular instances of the aforementioned embodiments, one of the route end points includes a building number and the textual output identifies the route end point as a building N buildings from the landmark along the road. In such a case, the term ‘N’ is some finite number.

Other embodiments of the present invention provide computer readable media that include instructions executable by a computer to receive two route end points and identify a route extending between the two route end points. The identified route includes two or more roads with one of the route end points existing along one of the roads and the other route end point existing along another of the roads. The instructions are further executable to identify at least one landmark along the identified route, and to assemble a textual output. The textual output includes the name of the first road, the name of the second road, a description of a transition between the first road and the second road, and a description of the landmark.

In some instances of the aforementioned embodiments, the computer readable medium further includes instructions executable by the computer to identify a side of the road on which one of the route end point is located, and to indicate such as part of the textual output. In other instances of the aforementioned embodiments, the computer readable medium further includes instructions executable by the computer to identify a distance from the landmark to one of the route end points; and to include the distance from the landmark to the route end point in the textual output. In various instances of the aforementioned embodiments, the computer readable medium further includes instructions executable by the computer to identify another landmark. In such a one of the landmarks may precede the route end point and the other landmark may come after the route end point along the identified route. In one or more instances of the aforementioned embodiments, the computer readable medium further includes instructions executable by the computer to identify a second building along the second road; and identify a location of one of the route end points along the second road relative to the first building and the second building. In such cases, the computer readable medium may further include instructions executable by the computer to incorporate the location of the route end point relative to the first building and the second building as a textual instruction that the route end point is a building N buildings from the first building along the second road and before the second building.

Yet other embodiments of the present invention provide systems for preparing directional instructions. Such systems include a computer, and a computer readable medium accessible to the computer and including instructions executable by the computer to: receive a first route end point and a second a route end point; identify a route between the first route end point and the second route end point; identify at least one landmark along the identified route; and assemble a textual output. The textual output includes the name of one or more roads included in the identified routes, a description of one or more transitions between the roads, and a description of the landmark.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a prior art graphical route and direction set;

FIGS. 2 shows a graphical route and direction set including landmark information in accordance with one or more embodiments of the present invention;

FIG. 3 is a flow diagram depicting a method in accordance with some embodiments of the present invention for preparing a textual direction set including landmark information in accordance with various embodiments of the present invention;

FIG. 4 depicts a system for preparing textual direction sets including landmark information in accordance with one or more embodiments of the present invention; and

FIG. 5 is a flow diagram depicting a method in accordance with other embodiments of the present invention for preparing a textual direction set including landmark information in accordance with various embodiments of the present invention.

### DETAILED DESCRIPTION OF THE INVENTION

The present invention is related to mapping systems, and more particularly, to systems and methods for providing textual direction instructions.

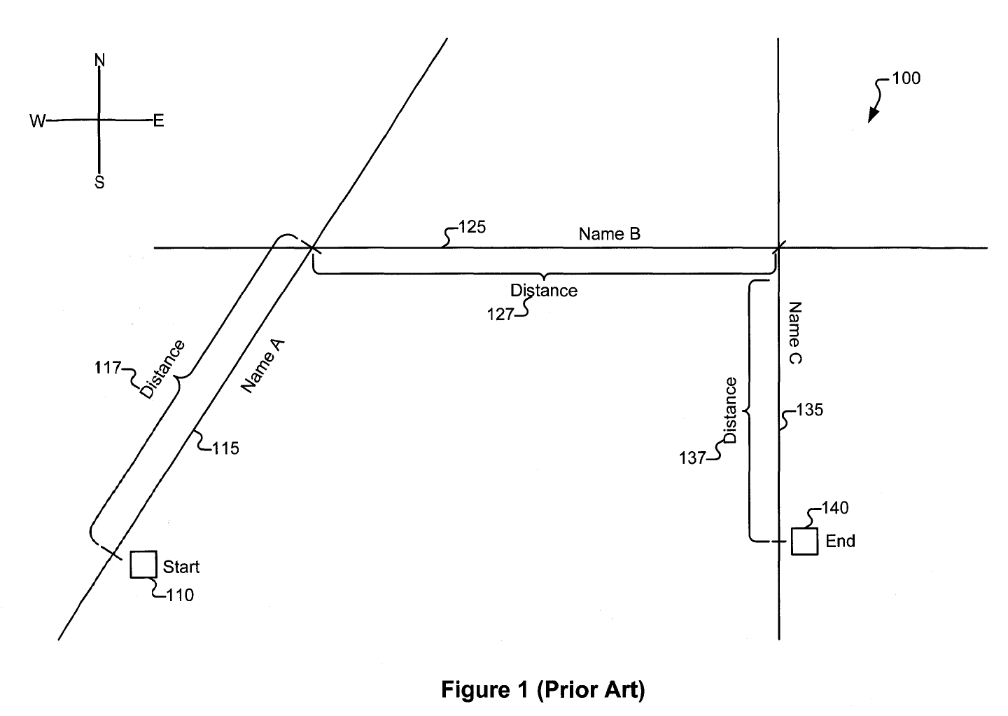

Turning to FIG. 1, a prior art graphical route and direction set 100 is depicted. Route and direction set 100 includes a route from a start point 110 to an end point 140 along three roads 115, 125, 135. Road 115 is designated road NAME A, road 125 is designated road NAME B, and road 135 is designated road NAME C. Route 100 includes traveling a distance 117 from start point 110 along road NAME A to road NAME B; traveling a distance 127 along road NAME B to road NAME C; and a distance 137 along road NAME C to end point 140. The graphical view of route and direction set 100 may be reduced to the following exemplary textual description:
(1) Travel North along road NAME A for a distance 117;
(2) Turn right on road NAME B;
(3) Travel East along road NAME B for a distance 127;
(4) Turn right on road NAME C; and
(5) Travel South along road NAME C for a distance 137.

### Again, such an approach may yield useful directions, but for a user that either cannot or fails to carefully monitor distances 117, 127, 137, the information is only of moderate value.

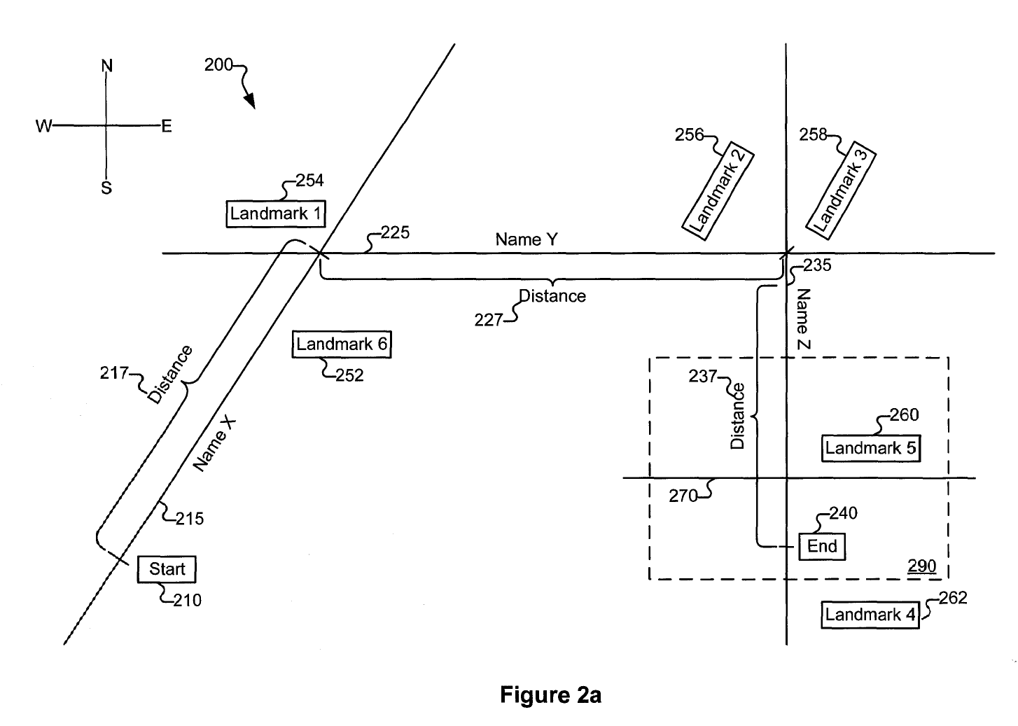

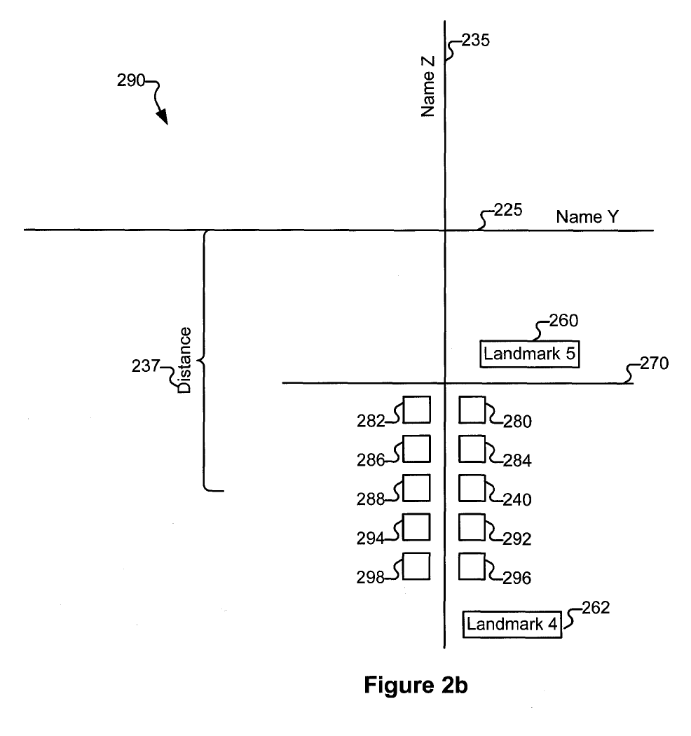

Turning to FIG. 2a, a graphical route and direction set 200 including landmark information in accordance with one or more embodiments of the present invention is shown. As used herein, the term “landmark” is used in a limited sense to indicate a building, park, sign, traffic signal, or geographic feature. Landmark does not include a street or intersection. Graphical route and direction set 200 includes a route from a start point 210 to an end point 240 along three roads 215, 225, 235. Road 215 is designated road NAME X, road 225 is designated road NAME Y, and road 235 is designated road NAME Z. Route 200 includes traveling a distance 217 from start point 210 along road NAME X passed a landmark 252 to road NAME Y. The intersection of road NAME X and road NAME Y occurs near landmark 252 and before a landmark 254. Route 200 progresses along road NAME Y for a distance 227 passed landmark 256 to road NAME Z. The intersection of road NAME Y and road NAME Z occurs near landmark 256 and before a landmark 258. Route 200 then progresses along road NAME Z for a distance 237 passed a landmark 260 (located on a road 270, but visible from road NAME Z 235) to road end point 240. End point 240 occurs near landmark 260 and before a landmark 262. The graphical view of route and direction set 200 may be reduced to the following exemplary textual description:
(1) Travel North along road NAME X for a distance 217 passed a landmark 252 to an intersection with road NAME Y;
(2) Turn right on road NAME Y;
(3) Travel East along road NAME Y for a distance 227 passed a landmark 252 to an intersection with road NAME Z;
(4) Turn right on road NAME Z; and
(5) Travel South along road NAME Z for a distance 237 passed a landmark 260.
   In other embodiments of the present invention, the aforementioned textual instructions may be augmented to include the landmarks that occur after an intersection or end point 240. In particular, the textual instructions may be augmented to read:
(1) Travel North along road NAME X for a distance 217 passed a landmark 252 to an intersection with road NAME Y;
NOTE: If you go passed landmark 254 you have gone too far.
(2) Turn right on road NAME Y;
(3) Travel East along road NAME Y for a distance 227 passed a landmark 252 to an intersection with road NAME Z;
NOTE: If you go passed landmark 258 you have gone too far.
(4) Turn right on road NAME Z; and
(5) Travel South along road NAME Z for a distance 237 passed a landmark 260.
NOTE: If you go passed landmark 262 you have gone too far.

Further, the textual instructions may be augmented to include distances relative to the landmarks. Thus, for example, distance 217 may be segregated into two distances: a distance (DISTANCE A) from start point 210 to landmark 252, and a distance (DISTANCE B) from landmark 252 to road NAME Y. Further, a distance (DISTANCE C) from road NAME Y to landmark 254 may be indicated. Similarly, distance 227 may be segregated into two distances: a distance (DISTANCE D) from road NAME X to landmark 256, and a distance (DISTANCE E) from landmark 256 to road NAME Z. Further, a distance (DISTANCE F) from road NAME Z to landmark 258 may be indicated. Similarly, distance 237 may be segregated into two distances: a distance (DISTANCE G) from road NAME Y to landmark 260, and a distance (DISTANCE H) from landmark 260 to end point 240. Further, a distance (DISTANCE I) from end point 240 to landmark 262 may be indicated. In this case, the following textual instructions may be provided to a user:
(1) Travel North along road NAME X for a (DISTANCE A) to a landmark 252, continuing passed landmark 252 for a (DISTANCE B) to an intersection with road NAME Y;
NOTE: If you go passed landmark 254 you have gone (DISTANCE C) too far.
(2) Turn right on road NAME Y;
(3) Travel East along road NAME Y for a (DISTANCE D) to a landmark 256, continuing passed landmark 256 for a (DISTANCE E) to an intersection with road NAME Z;
NOTE: If you go passed landmark 258 you have gone (DISTANCE F) too far.
(4) Turn right on road NAME Z; and
(5) Travel South along road NAME Z for a (DISTANCE G) to a landmark 260, continuing passed landmark 260 for a (DISTANCE H) to end point 240.
NOTE: If you go passed landmark 262 you have gone (DISTANCE I) too far.

At times, the final portion of the route is most difficult as a user may be attempting to identify a particular address or building. In such cases, the final portion of the route may be augmented with additional landmarks to aid a user in properly locating end point 240. To further discuss such embodiments of the present invention, an area 290 of graphical route and direction set 200 is magnified and shown as FIG. 2b. Turning to FIG. 2b, area 290 shows the route along road NAME Z from road NAME Y passed end point 240 to landmark 262. Of note, additional building landmarks 280, 282, 284, 286, 288, 292, 294, 296, 298 are identified around end point 240. Thus, for example, end point 240 may be a house in a residential area and building landmarks 280, 282, 284, 286, 288, 292, 294, 296, 298 may be other houses in the same general area as end point 240. In contrast, landmark 260 and landmark 262 may be more significant commercial or government buildings such as, for example, schools, banks, fire stations, grocery stores, or the like that are located in the same general area as end point 240. This additional information may be used to provide additional textual direction information regarding the last portion of the travel from start point 210 to end point 240. An example of such textual direction information follows:
(1) Travel North along road NAME X for a (DISTANCE A) to a landmark 252, continuing passed landmark 252 for a (DISTANCE B) to an intersection with road NAME Y;
NOTE: If you go passed landmark 254 you have gone (DISCTANCE C) too far.
(2) Turn right on road NAME Y;
(3) Travel East along road NAME Y for a (DISTANCE D) to a landmark 256, continuing passed landmark 256 for a (DISTANCE E) to an intersection with road NAME Z;
NOTE: If you go passed landmark 258 you have gone (DISTANCE F) too far.
(4) Turn right on road NAME Z; and
(5) Travel South along road NAME Z for a (DISTANCE G) to a landmark 260, continuing passed landmark 260 for a (DISTANCE H) to end point 240.
DETAIL: Shortly after passing landmark 260 you will come to a road 270. End point 240 is the third building on the left after road 270.
NOTE: If you go passed landmark 262 you have gone (DISTANCE I) too far.

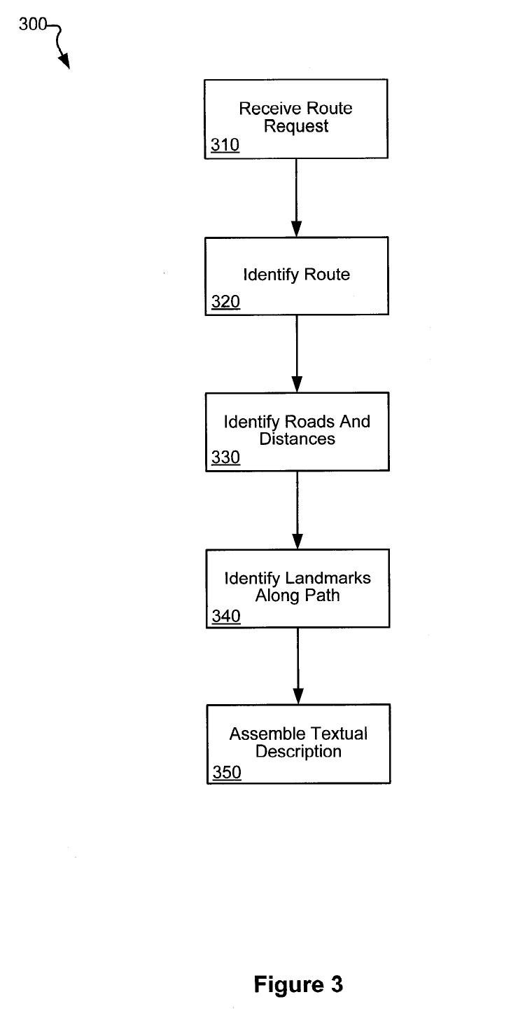

Turning to FIG. 3, a flow diagram 300 depicts a method in accordance with some embodiments of the present invention for preparing a textual direction set including landmark information in accordance with various embodiments of the present invention. Following flow diagram 300, a route request is received from a user (block 310). Such a route request may be received, for example, via an Internet website or a cellular telephone network that queries a user to enter two end points. One of the end points may be designated as a start point and the other designated as an end point. After receiving the route request (block 310), a computer accesses various road and travel information to identify a proposed route between two end points (block 320). One or more roads and one or more distances are identified that define the route between the two end points (block 330). Identification of roads and distances may be done using various approaches as are known in the art.

In addition, one or more landmarks along the proposed route are identified (block 340). This may include accessing a landmark database that includes a number of landmarks, and finding one or more significant landmarks that are located along one or more of the identified roads in the proposed route. Such landmarks may include, for example, buildings, land formations, statues or the like. Further, the landmark in the database may include a general description such as, for example, a ten story, brown building with greenish colored windows. As another example the landmark may be described as a mountain covered by trees that is approximately eight thousand feet in elevation. Based on the disclosure provided herein, one of ordinary skill in the art may recognize a variety of landmarks and descriptions associated therewith that may be identified in accordance with one or more embodiments of the present invention. Once the roads, distances and landmarks have been identified (blocks 330-340), a textual description of the route is assembled that includes the identified landmarks, roads and distances (block 350). The following provides an exemplary textual description including the landmark detail discussed above:
(1) Travel North along road NAME X for a (DISTANCE A) to a landmark A, continuing passed landmark A for a (DISTANCE B) to an intersection with road NAME Y;
LANDMARK A is a ten story, brown building located on the left side of road NAME X.
NOTE: If you go passed landmark B you have gone (DISCTANCE C) too far.
LANDMARK B is a pink colored grocery store located on the right of road NAME X.
(2) Turn right on road NAME Y;
(3) Travel East along road NAME Y for a (DISTANCE D) to a landmark C, continuing passed landmark C for a (DISTANCE E) to an intersection with road NAME Z;
LANDMARK C is a Bank with a drive through located on the right of road NAME Y.
NOTE: If you go passed landmark D you have gone (DISTANCE F) too far.
LANDMARK D is a twelve story apartment building located on the right of road NAME Y.
(4) Turn right on road NAME Z; and
(5) Travel South along road NAME Z for a (DISTANCE G) to a landmark E, continuing passed landmark E for a (DISTANCE H) to end point 240.
DETAIL: Shortly after passing landmark 260 you will come to a road 270. End point 240 is the third building on the left after road 270.
LANDMARK F is a twenty foot tall statue with a cannon located on top located east of road NAME Z.
NOTE: If you go passed landmark F you have gone (DISTANCE I) too far.
LANDMARK G is a public swimming pool located on the right of road NAME Z.

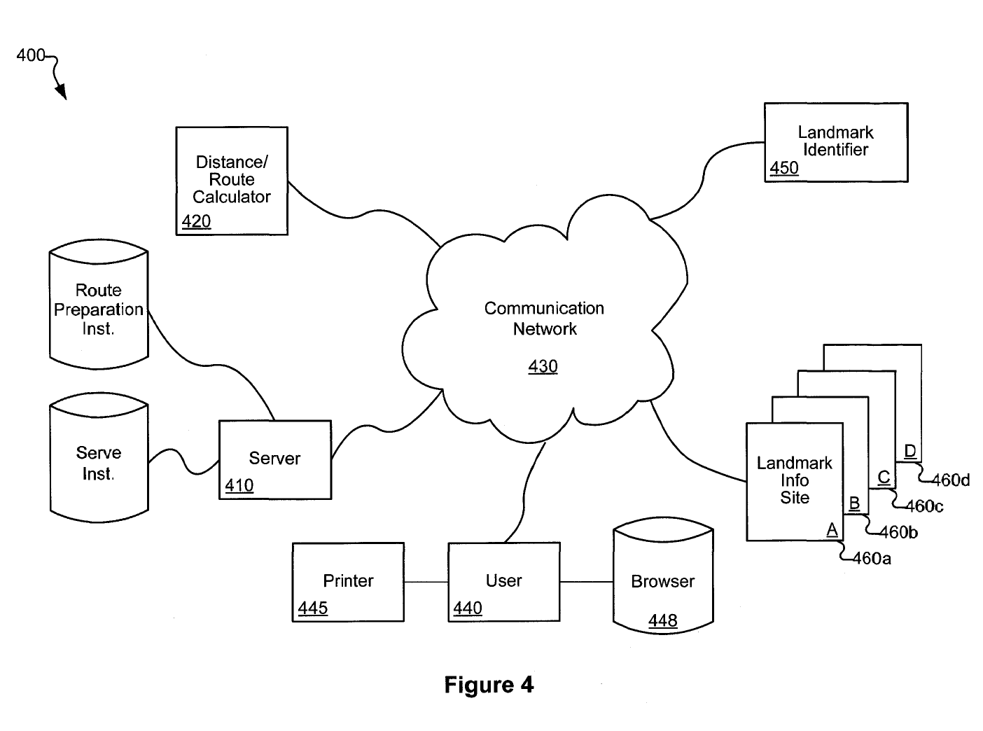

Turning to FIG. 4, a system 400 for preparing textual direction sets including landmark information in accordance with one or more embodiments of the present invention is shown. System 400 includes a user computer 440 that is communicably coupled to a number of information sources via a communication network 430. User computer 440 is associated with a printer 445 and a computer readable medium 448 that includes an Internet browser application. As used herein, the phrase “computer readable medium” is used in its broadest sense to mean any medium that is readable by a computer. Thus, as just some examples, a computer readable medium may include a hard disk drive, an optical storage media, a random access memory, a magnetic tape media, a CD-ROM, a floppy diskette, a flash drive, combinations of the aforementioned, or the like. Based on the disclosure provided herein, one of ordinary skill in the art will recognize a number of media that may be used as a computer readable medium to implement one or more embodiments of the present invention. The aforementioned Internet browser may be any application that allows a user to access one or more Internet sites via user computer 440. Printer 445 may be any device capable of rendering a hard copy of information obtained from user computer 440. User computer 440 may be any processor based device including, but not limited to, a personal computer, a notebook computer, a personal digital assistant, a cellular telephone, and/or the like.

Communication network 430 may be any network capable of allowing communications via one or more connected devices to one or more other connected devices. Thus, communication network 430 may be the Internet, a virtual private network, a local area network, a wide area network, a public switched telephone network, a cellular telephone network, combinations of the aforementioned, or the like. Further, the aforementioned connected devices may be, but are not limited to, computers, cellular telephones, personal digital assistants, and/or the like.

System 400 further includes a server 410 that is associated with a computer readable medium 414 including instructions executable by server 410 to serve one or more route preparation applications, and another computer readable medium 412 including instructions executable to serve one or more Internet websites allowing a user to request a route. Server 410 may be any processor based device that is capable of receiving information via communication network 430 from one area of system 400 and providing such information or a derivative thereof to another area of system 400. It should be noted that computer readable medium 412 and computer readable medium 414 may be included on the same computer readable medium or distributed across two or more computer readable media.

System 400 further includes a distance/route identification system 420 that is communicably coupled to communication network 430. Distance/route identification system 420 may be any system that is capable of receiving two or more end points and identifying a potential route between the two or more end points. Thus, as just one example, distance/route identification system 420 may be the commercially available Google™ maps and Mapquest™. Based on the disclosure provided herein, one of ordinary skill in the art will recognize that distance/route identification system 420 may be implemented using alternative technologies. Further, one of ordinary skill in the art will recognize that distance/route identification system 420 may be implemented as part of server 410.

System 400 also includes a landmark identification system 450 that is communicably coupled to communication network 430. Landmark identification system 450 may be any system that is capable of identifying one or more landmarks that lie along or near a particular route. Based on the disclosure provided herein, one of ordinary skill in the art will recognize that landmark identification system 450 may be implemented using various technologies known in the art including, but not limited to, computer technologies, database technologies, and/or search engine technologies. Further, one of ordinary skill in the art will recognize that landmark identification system 450 may be implemented as part of server 410.

In addition, system 400 may include a number of landmark information sites 460 that are accessible via communication network 430. Such landmark information sites may be any Internet web site that includes information about a landmark that may be along the determined route. Thus, as just one example, the landmark website may be a commercial website offering services that are provided at the identified landmark. Where the landmark is a hotel, it may offer a description of the hotel that can be incorporated in instructions on how to drive to a location using a route on which the hotel is located. As another example, the landmark site could be for an apartment complex along the route, a public swimming pool along the route, a library or school along the route. As a particular example, landmark site 460a may be identified by searching for a range of addresses occurring around the address of landmark 260 of FIG. 2a. Similarly, other landmark sites may be identified by searching for addresses occurring along the route depicted in FIG. 2a. Returned hits are further queried to determine whether a building or other landmark of significance is identified. From this, the other landmarks along the identified route can be gleaned.

All of the description information garnered about the particular landmark may be included in the textual directions provided to an end user. By using such landmark sites, information about a number of landmarks can be garnered without having to keep a database of all landmarks located in diverse areas. Further, descriptions of the landmarks may be updated by a third party operating a commercial entity in relation to the landmark and it is not necessarily the responsibility of the provider of directions to update the landmark descriptions. Based on the disclosure provided herein, one of ordinary skill in the art will recognize a variety of landmark sites that may be accessed via a communication network such as the Internet in accordance with one or more embodiments of the present invention. Further, based on the disclosure provided herein, one of ordinary skill in the art will recognize a variety of description information that may be gleaned from such sites and included in any finally prepare textual directions. Yet further, in some cases, route information may be obtained from such sites to the landmark at issue, and such route information may be used to modify the originally proposed route. Doing such may provide a more advantageous route based on personal travel experiences of people accustomed to driving to the location.

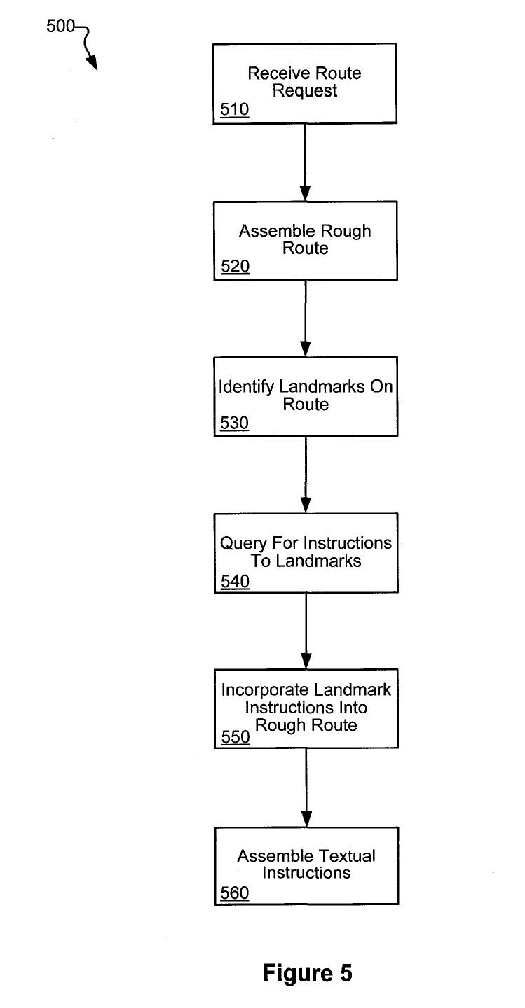

FIG. 5 is a flow diagram 500 depicting a method in accordance with other embodiments of the present invention for preparing a textual direction set including landmark information in accordance with various embodiments of the present invention. Following flow diagram 500, a route request is received from a user (block 510). Such a route request may be received, for example, via an Internet website or a cellular telephone network that queries a user to enter two end points. One of the end points may be designated as a start point and the other designated as an end point. After receiving the route request (block 510), server 410 accesses distance/route system 420 to obtain a rough route (block 520). In some instances, the aforementioned rough route includes the identification of one or more roads and one or more distances.

Then, server 410 accesses landmark system 450 to identify one or landmarks along the rough route (block 530). Alternatively, or in addition, identifying landmarks may include accessing a landmark database and finding one or more significant landmarks that are located along one or more of the identified roads in the proposed route. Such landmarks may include, for example, buildings, land formations, statues or the like. Further, the landmark in the database may include a general description such as, for example, a ten story, brown building with greenish colored windows. As another example the landmark may be described as a mountain covered by trees that is approximately eight thousand feet in elevation. Based on the disclosure provided herein, one of ordinary skill in the art may recognize a variety of landmarks and descriptions associated therewith that may be identified in accordance with one or more embodiments of the present invention. Once the roads, distances and landmarks have been identified (blocks 530-540), an information obtained from any landmark sites may be incorporated into the rough route to create a final route (block 550). This may, for example, include modifying the route to utilize roads identified in a landmark site for a land mark near the end point. Once the final route is defined, a textual description of the route is assembled that includes the identified landmarks, roads and distances (block 560). The following provides an exemplary textual description including the landmark detail discussed above:
(1) Travel North along road NAME X for a (DISTANCE A) to a landmark A, continuing passed landmark A for a (DISTANCE B) to an intersection with road NAME Y;
LANDMARK A is (INSERT description from accessed landmark site) located on the (INSERT location from accessed landmark site) of road NAME X.
NOTE: If you go passed landmark B you have gone (DISCTANCE C) too far.
LANDMARK B is (INSERT description from accessed landmark site) located on the (INSERT location from accessed landmark site) road NAME X.
(2) Turn right on road NAME Y;
(3) Travel East along road NAME Y for a (DISTANCE D) to a landmark C, continuing passed landmark C for a (DISTANCE E) to an intersection with road NAME Z;
LANDMARK C is (INSERT description from accessed landmark site) located on the (INSERT location from accessed landmark site) road NAME Y.
NOTE: If you go passed landmark D you have gone (DISTANCE F) too far.
LANDMARK D is (INSERT description from accessed landmark site) located on the (INSERT location from accessed landmark site) road NAME Y.
(4) Turn right on road NAME Z; and
(5) Travel South along road NAME Z for a (DISTANCE G) to a landmark E, continuing passed landmark E for a (DISTANCE H) to end point 240.
DETAIL: Shortly after passing landmark 260 you will come to a road 270. End point 240 is the third building on the left after road 270.
LANDMARK F is (INSERT description from accessed landmark site) located on the (INSERT location from accessed landmark site) road NAME Z.
NOTE: If you go passed landmark F you have gone (DISTANCE I) too far.
LANDMARK G is (INSERT description from accessed landmark site) located on the (INSERT location from accessed landmark site) road NAME Z.

Based on the foregoing discussion, it should be evident that one or more embodiments of the present invention may be used to provide descriptive directions that include house number information, the location of a house on a particular street, the location of a house relative to various other buildings on the street, and other advantageous uses. As other examples, embodiments of the present invention may be used to identify a building or house number immediately preceding an intersection in the route. Further, one or more embodiments of the present invention may be utilized to include an indication of whether addresses are increasing or decreasing as the user travels along a given road on the route, and/or whether even addresses are on the right hand or left hand side of the street as you travel down the road. With this information, a user may be able to determine if they have missed a turn on the route. Further, one or more embodiments of the present invention may be modified to identify an exit by name that immediately precedes the exit that is to be used by the user, or to identify by name a street that immediately precedes the street onto which the user is to turn. It will be appreciated that use of one or more of the aforementioned embodiments may be used to make travel easier. Further, such a system may be implemented using cell phone or other mobile technology to allow a user to update a route in real time. For example, such a system may utilize cell-phone based services such as Google™ SMS.

In conclusion, the present invention provides novel systems, devices, methods and arrangements for providing geographic directions. While detailed descriptions of one or more embodiments of the invention have been given above, various alternatives, modifications, and equivalents will be apparent to those skilled in the art without varying from the spirit of the invention. For example, a textual instruction may be in part based on a traffic signal. As a more particular example, the textual instructions may include, for example, “make a left at the third traffic light”. As other examples, the textual instructions may include, for example, “make a right at the second intersection”. As yet another example, the textual instructions may include, for example, “continue past the park on the left” or “make a left onto the bridge”. Therefore, the above description should not be taken as limiting the scope of the invention, which is defined by the appended claims.

What is claimed is:

1. A method for preparing directional instructions, the method comprising:
receiving a first route end point;
receiving a second route end point;
identifying a route between the first route end point and the second route end point, wherein at least one road and one distance are identified;
identifying at least one landmark along the identified route; and
assembling a textual output, wherein the textual output includes the name of the road, the distance and a description of the landmark.

2. The method of claim 1, wherein the second route end point is located along the road, and wherein the method further includes:
identifying which side of the road the second route end point is located; and indicating the side of the road as part of the textual output.

3. The method of claim 1, wherein the method further includes:
identifying a distance from the landmark to the second route end point; and
including the distance from the landmark to the second route end point in the textual output.

4. The method of claim 1, wherein the landmark is a first landmark, and wherein the method further includes:
identifying a second landmark, wherein the first landmark precedes the second route end point along the identified route, and wherein the second landmark comes after the second route end point along the identified route.

5. The method of claim 1, wherein the road is a first road, wherein identifying the route between the first route end point and the second route end point includes identifying a second road, and wherein the landmark is located near a transition between the first road and the second road along the identified route.

6. The method of claim 1, wherein identifying the route includes accessing an Internet website tailored for identifying routes, and wherein identifying the landmark includes accessing one or more Internet websites for entities located along the identified route.

7. The method of claim 6, wherein accessing the one or more Internet websites for entities located along the identified route includes:
deriving a description of a landmark associated with an entity, wherein the landmark is located along the route.

8. The method of claim 1, wherein the second route end point includes a building number, and wherein the landmark includes a group of buildings in proximity to the building number.

9. The method of claim 1, wherein the second route end point includes a building number, wherein the textual output identifies the second route end point as a building N buildings from the landmark along the road, and wherein N is a number.

10. A computer readable medium, wherein the computer readable medium includes instructions executable by a computer to:
receive a first route end point and a second a route end point;
identify a route between the first route end point and the second route end point, wherein at least two roads are identified, and wherein the first route end point lies on the first road and the second route end point lies along the second road;
identify at least one landmark along the identified route; and
assemble a textual output, wherein the textual output includes the name of the first road, the name of the second road, a description of a transition between the first road and the second road, and a description of the landmark.

11. The computer readable medium of claim 10, wherein the computer readable medium further includes instructions executable by the computer to:
identify which side of the second road that the second route end point is located; and indicating the side of the second road as part of the textual output.

12. The computer readable medium of claim 10, wherein the computer readable medium further includes instructions executable by the computer to:
identify a distance from the landmark to the second route end point; and
include the distance from the landmark to the second route end point in the textual output.

13. The computer readable medium of claim 10, wherein the computer readable medium further includes instructions executable by the computer to:
identify a second landmark, wherein the first landmark precedes the second route end point along the identified route, and wherein the second landmark comes after the second route end point along the identified route.

14. The computer readable medium of claim 10, wherein the landmark is a first building along the second road, wherein the computer readable medium further includes instructions executable by the computer to:
identify a second building along the second road; and
identify a location of the second route end point along the second road relative to the first building and the second building.

15. The computer readable medium of claim 14, wherein the computer readable medium further includes instructions executable by the computer to:
incorporate the location of the second route end point relative to the first building and the second building as a textual instruction that the second route end point is a building N buildings from the first building along the second road and before the second building, and wherein N is a number.

16. A system for preparing directional instructions, the system comprising:
a computer; and
a computer readable medium accessible to the computer and including instructions executable by the computer to:
receive a first route end point and a second a route end point;
identify a route between the first route end point and the second route end point, wherein at least two roads are identified, and wherein the first route end point lies on the first road and the second route end point lies along the second road;
identify at least one landmark along the identified route; and
assemble a textual output, wherein the textual output includes the name of the first road, the name of the second road, a description of a transition between the first road and the second road, and a description of the landmark.

17. The system of claim 16, wherein the landmark is a first building along the second road, wherein the computer readable medium further includes instructions executable by the computer to:
identify a second building along the second road; and
identify a location of the second route end point along the second road relative to the first building and the second building.

18. The system of claim 17, wherein the computer readable medium further includes instructions executable by the computer to:
incorporate the location of the second route end point relative to the first building and the second building as a textual instruction that the second route end point is a building N buildings from the first building along the second road and before the second building, and wherein N is a number.

19. The system of claim 16, wherein the computer readable medium further includes instructions executable by the computer to:
identify which side of the second road that the second route end point is located; and indicating the side of the second road as part of the textual output.

20. The system of claim 16, wherein the computer readable medium further includes instructions executable by the computer to:
identify a distance from the landmark to the second route end point; and
include the distance from the landmark to the second route end point in the textual output.
